(19) United States
(12) Patent Application Publication
(10) Pub. No.: US 2025/0216207 A1
(43) Pub. Date: Jul. 3, 2025

(54) COMBINED WALKING AND DRIVING ROUTES FOR AUTONOMOUS VEHICLE RIDES

(71) Applicant: GM Cruise Holdings LLC, San Francisco, CA (US)

(72) Inventors: Patrick Tyler Haas, San Francisco, CA (US); Yufeng Liu, Moraga, CA (US); Yike Li, Fremont, CA (US); Or Cohen, San Francisco, CA (US)

(73) Assignee: GM Cruise Holdings LLC, San Francisco, CA (US)

(21) Appl. No.: 18/401,912

(22) Filed: Jan. 2, 2024

(51) Int. Cl. G01C 21/34; B60W 60/00

(52) U.S. Cl. CPC G01C 21/3423; G01C 21/3438; B60W 60/00253

(57) ABSTRACT

A walking path database stores data describing a set of connected walking paths. The walking path database may be generated based on an existing map database describing connected roads. The walking path database and map database are used to generate a combined walking and driving route, where a user walks to a particular pickup location, and a vehicle drives the user from the pickup location to a particular destination. The combined walking and driving route may be a route that minimizes the overall trip time.

### TECHNICAL FIELD OF THE DISCLOSURE

The present disclosure relates generally to autonomous vehicles and, more specifically, to methods and systems for generating walking directions and determining routes with suitable pickup and drop-off locations for autonomous vehicles.

### BACKGROUND

Fleets of autonomous vehicles (AVs) can provide various travel services, such as passenger transport and delivery transport. AVs carry out such services by autonomously driving along a network of interconnected roads. AVs may not be able to travel on certain roads, e.g., if a road is temporarily closed, or if the road is unsuitable for the AV to travel on due to low visibility, poor conditions, high pedestrian activity, or other factors. Furthermore, the AVs may only be able to stop along certain roads or at certain locations, e.g., an AV can only stop along a road if there is a suitable stopping lane or parking space. The suitable stopping locations may be different from a user's desired pickup location or drop-off location. For example, due to stopping restrictions, an AV may drop off a passenger 200 meters from the passenger's destination. If the AV selects the closest suitable stopping location to a desired pickup location or drop-off location, this can create an overly long trip duration, e.g., if several left turns are required to reach a particular drop-off location.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a block diagram illustrating a system including an example AV fleet and fleet management system for providing a ride service according to some embodiments of the present disclosure;

FIG. 2 is an illustration of a map with a user's location, eligible pickup locations, and a destination location, and several potential walking and driving routes between the user's location and the destination location, according to some embodiments of the present disclosure;

FIG. 3 is a block diagram illustrating example components of a sensor suite of an AV according to some embodiments of the present disclosure;

FIG. 4 is a block diagram illustrating example components of an onboard computer of an AV according to some embodiments of the present disclosure;

FIG. 5 is a block diagram illustrating example components of a fleet management system according to some embodiments of the present disclosure;

FIG. 6 is a flow diagram of a process for generating a walking path database, according to some embodiments of the present disclosure;

FIG. 7 is a flow diagram of a process for selecting a combined walking and driving route with a particular pickup location, according to some embodiments of the present disclosure; and

FIG. 8 is a flow diagram of a process for selecting a combined walking and driving route with a particular drop-off location, according to some embodiments of the present disclosure.

### DESCRIPTION OF EXAMPLE EMBODIMENTS OF THE DISCLOSURE

### Overview

The systems, methods and devices of this disclosure each have several innovative aspects, no single one of which is solely responsible for all of the desirable attributes disclosed herein. Details of one or more implementations of the subject matter described in this specification are set forth in the description below and the accompanying drawings.

AVs travel between locations on networks of roads. The road network may include public roads (e.g., city streets, highways, etc.) and private roads (e.g., driveways and other roads on private property). The road network may also include parking areas, such as parking spaces or parking lots, and other types of surfaces on which the AV may drive. When AVs perform services for users, AVs generally aim to drive from a specific location (e.g., a pickup location of a passenger, or a restaurant with food for delivery) to a specific location (e.g., a drop-off location for the passenger, or a requested drop-off location for the food delivery). However, real road networks have various limitations and rules, such as geographic constraints, temporary closures, and one-way traffic rules, which limit which locations AVs can get to, as well as how long it takes AVs to get to specific locations, how close AVs can get to each of the specific locations, and whether AVs can stop at the specific locations. For example, an AV may only be able to stop in certain areas, such as legal parking spots, or along roads where through-traffic can navigate around the AV.

The distance users are willing to walk between the AV and their origin or destination point can vary between users and between different use cases. AVs and other ride services typically drive as close as they can to a user's origin location and destination location. However, many users prefer a shorter overall trip duration and are willing to walk a longer distance if it reduces the overall duration to get from their origin location to their desired destination. In some cases, a ride service allows a user to select a particular location for pickup and/or drop-off, but it can be difficult for users to determine the optimal location for pickup or drop-off.

As described herein, a routing system can determine a route from a user's origin location to a destination location that includes at least one walking segment and at least one driving segment. For example, to pick up a user, the routing system can identify a set of eligible pickup locations near the origin location, e.g., the user's current location. The pickup locations are locations where a vehicle can stop, e.g., a parking area or a portion of a road that allows temporary stopping. The routing system generates walking segments from the origin location to the different pickup locations, and driving segments from the different pickup locations to the destination location. The routing system scores the combined routes for each of the pickup locations, where each combined route includes a walking segment to a particular pickup location plus a driving segment from the particular pickup location. The score is based at least in part on a time to traverse the walking segment of the combined route and a time to traverse the driving segment of the combined route. The routing system selects one of the combined routes based on the scores. For example, the routing system may select the combined route that is expected to get the user from the origin location to the destination location in the shortest time. The routing system may instruct an AV to drive to the pickup location for the route to pick up the user, and instruct the user to walk to the pickup location. The routing system may perform a similar process for selecting a drop-off location, e.g., selecting a drop-off location where the combined drive time plus walk time from the drop-off location to the user's destination location is minimized.

The routing system may rely on a walking path database that includes data describing pathways suitable for pedestrian traffic. The walking path database may be populated, at least in part, based on existing map data of an AV service. For example, the walking path data may include the sides of roadways in the map database; these paths may correspond to designated shoulders, sidewalks, edges of streets, public right-of-ways, etc. The walking path data may also include data describing intersections, including marked crosswalks. If an intersection is controlled by a traffic control, such as a stoplight (with or without a pedestrian signal) or a stop sign, the walking path database may include data describing the intersection control. The walking paths may be arranged in a graph, where the graph indicates connections between walking paths.

In some embodiments, the walking path database includes data based on observed pedestrian behavior perceived by AVs in an AV fleet. For example, if AVs driving on a particular roadway observe no or infrequent pedestrians on the sides of the roadway (e.g., fewer pedestrians than other roadways in the region), walking paths along that roadway may be removed from, or not included in, the walking path database. As another example, if AVs perceive pedestrians frequently walking from one side of a roadway to the other outside of intersections or designated crosswalks (e.g., jaywalking on a quiet, residential street), the walking path database may indicate that pedestrians can cross the roadway at any point. This can impact routing decisions, e.g., by requiring an AV stop on a particular side of the street to drop off a passenger if jaywalking is not typical, or allowing an AV to stop on either side of a street to drop off the passenger if jaywalking is typical.

As will be appreciated by one skilled in the art, aspects of the present disclosure, in particular aspects of generating combined walking and driving routes for AV rides, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices and/or their controllers, etc.) or be stored upon manufacturing of these devices and systems.

The following detailed description presents various descriptions of certain specific embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

### Example AV System for Providing a Ride Service

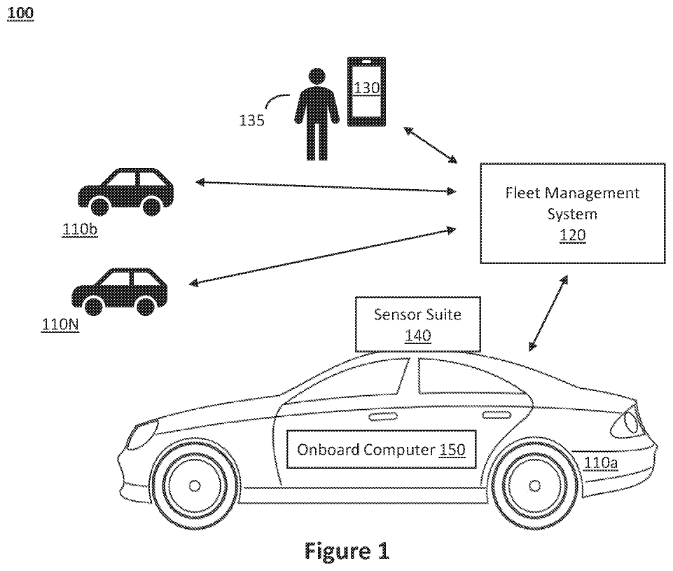

FIG. 1 is a block diagram illustrating a system 100 including an example AV fleet and fleet management system for providing a ride service according to some embodiments of the present disclosure. The system 100 includes a fleet of AVs 110, including AV 110a, AV 110b, and AV 110N, a fleet management system 120, and a user device 130. For example, a fleet of AVs may include a number N of AVs, e.g., AV 110a through AV 110N. AV 110a includes a sensor suite 140 and an onboard computer 150. AVs 110b through 110N also include the sensor suite 140 and onboard computer 150. A single AV in the fleet is referred to herein as AV 110, and the fleet of AVs is referred to collectively as AVs 110.

The fleet management system 120 receives service requests for the AVs 110 from user devices, such as user device 130. For example, a user 135 accesses an app executing on the user device 130 and, using the app, enters a ride request including an origin location and a destination location. The fleet management system 120 dispatches AVs 110 to carry out the service requests. The fleet management system 120 also maintains a map database. When an AV 110 is dispatched for a service request, the fleet management system 120 and/or the AV 110 determines a route for the AV 110 to follow based on the data in the map database, including locations at which the AV 110 can stop for user interactions, such as a user entering or exiting the AV 110, or loading or unloading items from the AV 110. For example, the fleet management system 120 or AV 110 determines a particular location where the AV 110 can stop to pick up a passenger (referred to as a pickup location) or drop off a passenger (referred to as a drop-off location).

The pickup location may be different from the origin location but is near to the origin location, e.g., within walking distance of the origin location. As described herein, the pickup location may be selected to reduce the overall time for the user to reach the destination location, based on combined time for walking from the origin location to the pickup location and the time to drive from the pickup location to the destination or drop-off location. Similarly, the drop-off location may be different from the destination location, but is near to the destination location, e.g., within walking distance of the destination location. In some embodiments, when the AV 110 is performing a delivery service, the fleet management system 120 and/or AV 110 determines a stopping location for the AV 110 can stop so that a user can access the AV 110 to collect a delivery item. The stopping location may be near the destination location for delivery, e.g., walking distance away from the user's desired destination.

The AV 110 is preferably a fully autonomous automobile, but may additionally or alternatively be any semi-autonomous or fully autonomous vehicle; e.g., a boat, an unmanned aerial vehicle, a self-driving car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., windshield wipers, headlights, turn indicators, air conditioning, etc.

The AV 110 includes a sensor suite 140, which includes a computer vision (“CV”) system, localization sensors, and driving sensors. For example, the sensor suite 140 may include photodetectors, cameras, radar, sonar, lidar, GPS, wheel speed sensors, inertial measurement units (IMUs), accelerometers, microphones, strain gauges, pressure monitors, barometers, thermometers, altimeters, etc. The sensors may be located in various positions in and around the AV 110.

An onboard computer 150 is connected to the sensor suite 140 and functions to control the AV 110 and to process sensed data from the sensor suite 140 and/or other sensors in order to determine the state of the AV 110. Based upon the vehicle state and programmed instructions, the onboard computer 150 modifies or controls behavior of the AV 110. For example, the onboard computer 150 maneuvers the AV 110 according to routing selections determined by an onboard or remote navigation system.

The onboard computer 150 is preferably a general-purpose computer adapted for I/O communication with vehicle control systems and sensor suite 140, but may additionally or alternatively be any suitable computing device. The onboard computer 150 is preferably connected to the Internet via a wireless connection (e.g., via a cellular data connection). Additionally or alternatively, the onboard computer 150 may be coupled to any number of wireless or wired communication systems.

The fleet management system 120 manages the fleet of AVs 110. The fleet management system 120 may manage a service that provides or uses the AVs 110, e.g., a service for providing rides to users with the AVs 110, or a service that delivers items, such as prepared foods, groceries, or packages, using the AVs 110. The fleet management system 120 may select an AV from the fleet of AVs 110 to perform a particular service or other task, and instruct the selected AV (e.g., AV 110a) to autonomously drive to a particular location (e.g., a pickup address or a delivery address). If the AV 110 cannot drive directly to a particular address or location, or cannot stop at the location, the fleet management system 120 may select a nearby location where the AV 110 can drive to and stop. The fleet management system 120 may select a route for the AV 110 to follow. The fleet management system 120 also manages fleet maintenance tasks, such as charging and servicing of the AVs 110.

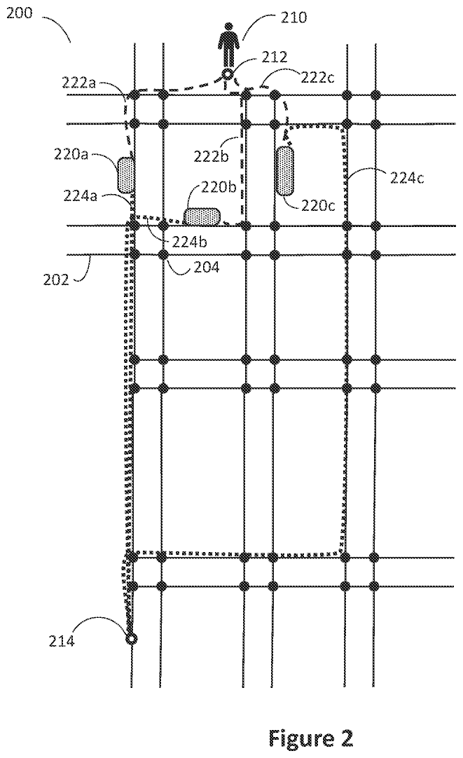

As shown in FIG. 1, each of the AVs 110 communicates with the fleet management system 120. The AVs 110 and fleet management system 120 may connect over a public network, such as the Internet. The fleet management system 120 is described further in relation to FIG. 2.

The user device 130 is a personal device of the user 135, e.g., a smartphone, tablet, computer, or other device for interfacing with a user of the fleet management system 120. The user device 130 may provide one or more applications (e.g., mobile device apps or browser-based apps) with which the user 135 can interface with a service that provides or uses AVs. The service, and the AVs 110 associated with the service, are managed by the fleet management system 120, which may also provide the application to the user device 130. In other embodiments, the service is managed by a separate system (e.g., a food delivery service) that relies on the AV fleet for some or all of its transportation tasks and interacts with the fleet management system 120 to arrange transportation tasks.

An application provided by the fleet management system 120 may provide various user interfaces to the user 135. In some embodiments, the application may display a map showing the user's origin location and a pickup location selected by the fleet management system 120 or the AV 110. In some embodiments, the application may display a map showing the user's destination location and a drop-off location selected by the fleet management system 120 or the AV 110. The application may provide a walking route or walking directions from the origin location to the pickup location and/or from the drop-off location to the destination location. In other examples, the origin location, pickup location, drop-off location, and/or destination location may be provided from the fleet management system 120 to a second service provider, which may provide maps and/or directions to the user devices 130 through a separate application.

Example Map with Stopping Locations and Walking and Driving Routes

FIG. 2 is an illustration of a map 200 with a user's location, eligible pickup locations, and a destination location, and several potential walking and driving routes between the user's location and the destination location, according to some embodiments of the present disclosure.

The map 200 includes lanes represented as lines 202. Connections between lanes are represented as nodes, e.g., node 204. In this example, each road has two lanes, one traveling in each direction. The map 200 represents lanes in a right-hand traffic flow pattern, where vehicles keep to the right side of the road.

A user 210 is at an origin location 212, which is slightly offset from a road. The map 200 further includes a destination location 214, where the 210 wishes to travel. The user 210, which may correspond to the user 135, may input the origin location 212 and destination location 214 into an application on the user device 130, as described above. The origin location 212 may be the current location of the user 135.

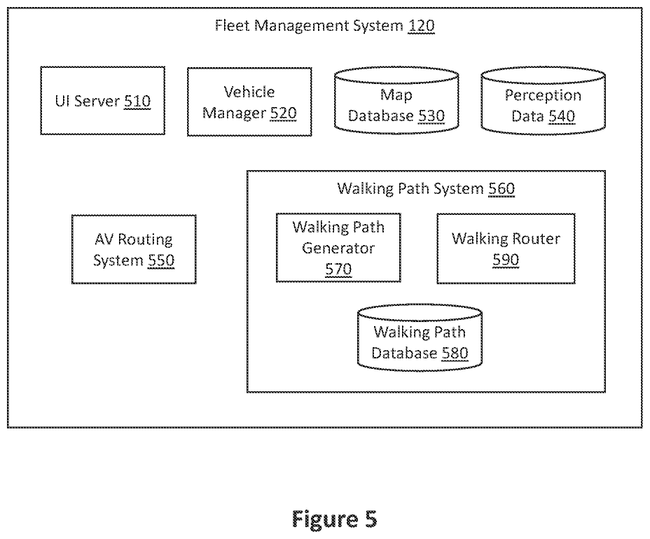

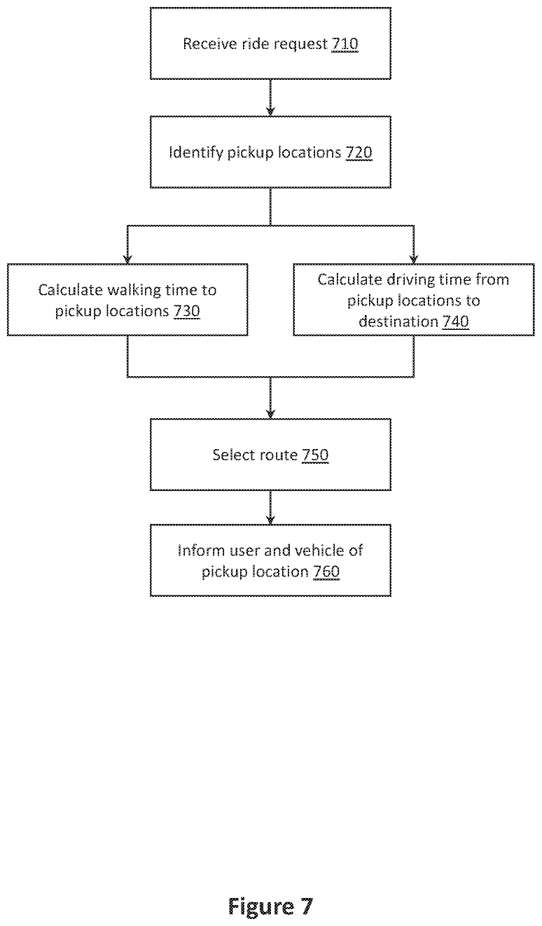

In response to receiving the origin location 212 and destination location 214 of the user, the fleet management system 120 may identify possible pickup locations proximate to the origin location 212. Three pickup locations 220a, 220b, and 220c are illustrated on the map 200. The pickup locations 220 may correspond to stopping locations, which may be represented in a database accessible to and/or maintained by the fleet management system 120. As used herein, a stopping location is a portion of a road network along which an AV 110 can stop or park. A stopping location can include a portion of a roadway dedicated to parking (e.g., a parking lane), a portion of a road that allows temporary stopping (e.g., a loading zone, a designated drop-off or pickup zone), a parking spot, or another surface connected to the road network in which an AV 110 can stop for a period of time to enable user interaction with the AV 110. In some embodiments, a traveling lane (i.e., a portion of a road network along which an AV 110 can travel) or a portion of a traveling lane may be used as a stopping location, e.g., if an AV 110 may double park on the traveling lane, or if the traveling lane is wide enough that other traffic may continue to pass the AV 110 if the AV 110 stops or parks along the side of the traveling lane. A particular location may or may not be a stopping location at different times of day (e.g., a valet zone may be a stopping location during off-hours), for different users (e.g., a handicap parking spot may be used as a stopping location for disabled passengers), based on traffic patterns (e.g., the AV 110 may stop in a traveling lane when there is little other traffic along the roads), or based on other factors. Identifying stopping locations as potential pickup locations is described further in relation to FIGS. 5 and 7.

Having identified the pickup locations 220, the fleet management system 120 or another system (e.g., a separate routing system) determines walking routes to each of the pickup locations 220 and driving routes from each of the pickup locations 220 to the destination location 214. In particular, the walking route 222a is a route from the origin location 212 to the pickup location 220a; the walking route 222b is a route from the origin location 212 to the pickup location 220b; and the walking route 222c is a route from the origin location 212 to the pickup location 220c. The driving route 224a is a route from the pickup location 220a to the destination location 214; the driving route 224b is a route from the pickup location 220b to the destination location 214; and the driving route 224c is a route from the pickup location 220c to the destination location 214.

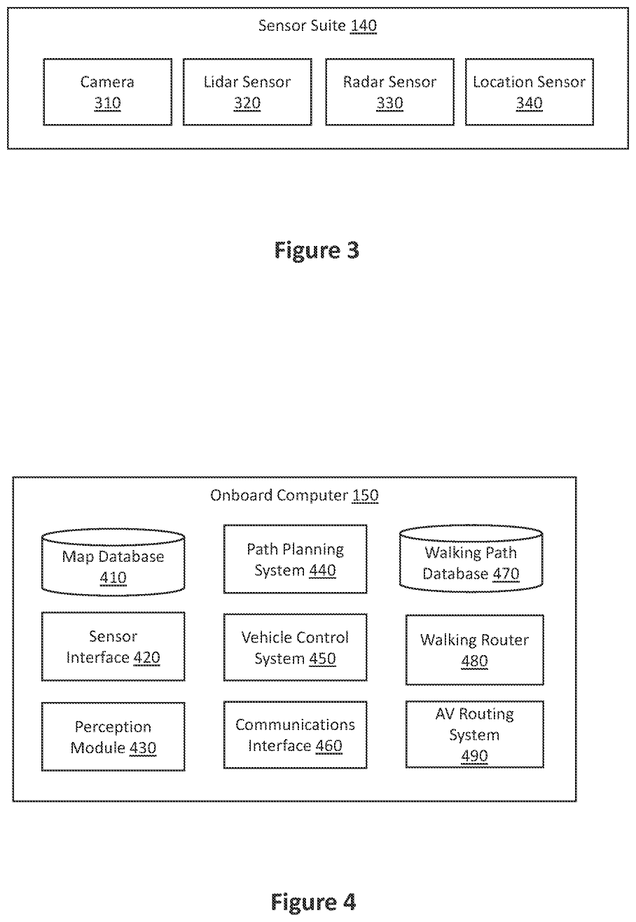

The driving routes 224 may be generated based on a map database that describes the road network. The walking routes 222 may be generated based on a walking path database, e.g., a graph of walking paths. The walking path database may be generated based on the map database, e.g., to include paths along the sides of roads in the map database, and to include crosswalks described in the map database. The walking path database may further be populated or modified based on data collected by AVs 110, e.g., data describing observed pedestrian pathways, or data describing temporary sidewalk closures or other walking path impediments. The walking path database may include data describing intersection controls and/or other pedestrian controls, which can impact the time for pedestrians to cross intersections or roads. The walking path database is described further in relation to FIGS. 4 and 5.

Each walking route 222 can be combined with a driving route 224 to form a combined route. For example, a first combined route includes the walking route 222a and the driving route 224a. The walking routes 222 may be considered walking segments of the respective combined routes, and the driving routes 224 may be considered driving segments of the respective combined routes. A score may be generated for each combined route to compare the combined routes. For example, the score for the first combined route may include a time for the user 210 to walk from the origin to the pickup location 220a plus a time for the AV 110 to drive from the pickup location 220a to the destination location 214. Scoring the routes is described in further detail with respect to FIGS. 5 and 7.

A routing system selects one of the combined routes based on the scores. The AV 110 and the user 210 may each be instructed to go to the pickup location 220. The application on the user device 130 may provide the walking route or walking directions to the selected pickup location 220 to the user 210. The pickup location of the selected combined route may be different from a pickup location selected without scoring the walking routes and/or scoring the combined routes. For example, instead of the scoring process, a routing system may choose the pickup location closest to the origin location 212; in this case, the closest pickup location is the location 220c. However, the driving route 224c from the pickup location 220c to the destination location 214 is relatively long and has a lot of turns, and thus the driving route 224c may take a longer time relative to the alternate routes 224a and 224b. Thus, when considering the combined scores of the walking and driving routes, a routing system may select the pickup location 220a or 220b, which would have a slightly longer walk, but an overall lower trip time than pickup location 220c.

### Example Sensor Suite

FIG. 3 is a block diagram illustrating example components of a sensor suite 140, according to some embodiments of the present disclosure. FIG. 3 includes various sensors that may be included in a sensor suite of a vehicle. The sensor suite 140 includes a set of environmental sensors, e.g., a camera 310, a lidar sensor 320, a radar sensor 330. The sensor suite 140 further includes a location sensor 340. While one of each of the sensors 310, 320, 330, and 340 is shown in FIG. 3, the sensor suite 140 may include more than one of each of these components, e.g., to capture the environment from different positions and angles, or for redundancy.

The sensor suite 140 includes multiple types of environmental sensors, each of which has different attributes and advantages. Combining data from multiple sensors and different sensor types allows an AV (e.g., the AV 110) to obtain a more complete view of its environment. For example, combining data from multiple sensors and different types of sensors allows a vehicle to learn about its environment in different conditions, e.g., at different travel speeds, and in different lighting conditions.

Different and/or additional components not shown in FIG. 3 may be included in the sensor suite 140. For example, the sensor suite 140 may also include photodetectors, sonar, GPS, wheel speed sensors, IMUs, accelerometers, microphones, strain gauges, pressure monitors, barometers, thermometers, altimeters, etc., as described with respect to the sensor suite 140 of FIG. 1. In some embodiments, a single sensor or set of sensors may obtain location and speed data, e.g., the sensor suite 140 may include one or more IMUs and GPS sensors, which collect data that can be used to derive speed and location.

The camera 310 captures images of the environment around the AV 110. The sensor suite 140 may include multiple cameras 310 to capture different views, e.g., a front-facing camera, a back-facing camera, and side-facing cameras. The cameras 310 may be implemented using high-resolution imagers with fixed mounting and field of view. One or more cameras 310 may capture light at different frequency ranges. For example, the sensor suite 140 may include one or more infrared cameras and/or one or more ultraviolet cameras in addition to visible light cameras.

The lidar sensor 320 measures distances to objects in the vicinity of the AV 110. The lidar sensor 320 may be a scanning lidar that provides a point cloud of the region scanned. The lidar sensor 320 may have a fixed field of view or a dynamically configurable field of view.

The radar sensor 330 measures ranges and speeds of objects in the vicinity of the AV 110 using reflected radio waves. The radar sensor 330 may be implemented using a scanning radar with a fixed field of view or a dynamically configurable field of view. As described with respect to the cameras 310, the sensor suite 140 may include multiple radar sensors 330 to capture different fields of view. Radar sensors 330 may include articulating radar sensors, long-range radar sensors, short-range radar sensors, or some combination thereof.

In some embodiments, other types of time-of-flight sensors, such as time-of-flight cameras, infrared depth sensors, 3D scanners, structured light scanners, or other types of ranging techniques are used in addition to or instead of lidar and/or radar. Any time-of-flight sensor or ranging sensor may provide data in the form of a point cloud, or data (e.g., range data) from which a point cloud may be derived.

The location sensor 340 determines a current location of the AV 110. The location sensor 340 may include or be coupled to a GPS sensor and one or more IMUs and/or accelerometers. The location sensor 340 may include a processing unit (e.g., a module of the onboard computer 150, or a separate processing unit) that receives signals (e.g., GPS data and IMU data) to determine the current location of the AV 110.

### Example Onboard Computer

FIG. 4 is a block diagram illustrating example components of an onboard computer 150 of an AV according to some embodiments of the present disclosure. The onboard computer 150 includes a map database 410, a sensor interface 420, a perception module 430, a path planning system 440, a vehicle control system 450, a communications interface 460, a walking path database 470, a walking router 480, and an AV routing system 490. In alternative configurations, fewer, different and/or additional components may be included in the onboard computer 150. For example, components and modules for controlling various vehicle functions (e.g., heating and cooling, user interactions, doors and windows, etc.), and components and modules for communicating with other systems, such as the fleet management system 120, are not shown in FIG. 4. Further, functionality attributed to one component of the onboard computer 150 may be accomplished by a different component included in the onboard computer 150 or a different system from those illustrated.

The map database 410 stores a detailed map that includes a current environment of the AV 110. The map database 410 includes data describing roadways, such as locations of roadways, connections between roadways, roadway names, speed limits, traffic flow regulations, toll information, etc. The map database 410 may further include data describing other features, such as bike lanes, sidewalks, crosswalks, traffic controls (e.g., traffic lights, stop signs, yield signs, etc.), parking lots, etc. In some embodiments, the map database 410 includes data describing walking paths; in other embodiments, walking paths are described in a separate walking path database 470, described below.

The sensor interface 420 interfaces with the sensors in the sensor suite 140. The sensor interface 420 is configured to receive data captured by sensors of the sensor suite 140, described above. For example, the sensor interface 420 may have subcomponents for interfacing with individual sensors or groups of sensors of the sensor suite 140, such as a camera interface, a lidar interface, a radar interface, a location sensor interface, etc. The sensor interface 420 may request data from the sensor suite 140, e.g., by requesting that a sensor capture data in a particular direction or at a particular time.

The perception module 430 identifies objects in the environment of the AV 110. The sensor suite 140 produces a data set that is processed by the perception module 430 to detect other cars, pedestrians, trees, bicycles, and objects traveling on or near a road on which the AV 110 is traveling or stopped, and indications surrounding the AV 110 (such as construction signs, traffic cones, traffic lights, stop indicators, and other street signs). For example, the data set from the sensor suite 140 may include images obtained by cameras, point clouds obtained by lidar (light detecting and ranging) sensors, and data collected by radar sensors. The perception module 430 may include one or more classifiers trained using machine learning to identify particular objects. In some embodiments, the perception module 430 is capable of perceiving pedestrians. The perception module 430 may distinguish between people who are walking along a roadway and people who may be next to or in a roadway for other reasons, e.g., a stationary person waiting to be picked up, an emergency worker, a person near a disabled vehicle, etc. In some embodiments, a multi-class classifier may be used to classify each object in the environment of the AV 110 as one of a set of potential objects, e.g., a vehicle, a pedestrian, or a cyclist. As another example, a pedestrian classifier recognizes pedestrians in the environment of the AV 110, a vehicle classifier recognizes vehicles in the environment of the AV 110, etc.

In some embodiments, the perception module 430 executes one or more processes for identifying restrictions or blockages on walking paths. For example, the perception module 430 may identify objects that impede movement of people along a sidewalk, in a shoulder, and/or along the side of a roadway. For example, street construction may block a roadway, including the shoulder or side of a roadway. As another example, a delivery truck parked over a sidewalk may block the sidewalk. As another example, a sidewalk may have signs and/or barricades indicating that a sidewalk is temporarily closed.

The path planning system 440 plans maneuvers for the AV 110 based on map data retrieved from the map database 410, data received from the perception module 430, and navigation information, e.g., a drop-off location instructed by the fleet management system 120 and a current location of the AV 110. In some embodiments, the AV routing system 490, or a routing system at the fleet management system 120, may determine an overall route to a destination (e.g., a selected drop-off location). Along the selected route, the path planning system 440 may make granular path decisions, e.g., selecting a particular lane on a given stretch of road for the AV 110 to travel along, or selecting a path that involves changing from one lane to another lane at a particular point along the roadway. The path planning system 440 may further determine speeds and/or accelerations at different points along a determined path. The path planning system 440 may continuously modify the path based on additional inputs from the sensor interface 420 and/or perception module 430, e.g., to account for behavior of surrounding traffic, pedestrians, bicyclists, etc.; to account for dynamic traffic signals; and based on other real-time factors.

The vehicle control system 450 instructs the movement-related subsystems of the AV 110 to maneuver according to the pathway determined by the path planning system 440. The vehicle control system 450 may include the throttle interface for controlling the engine throttle, motor speed (e.g., rotational speed of electric motor), or any other movement-enabling mechanism; the brake interface for controlling the brakes of the AV 110 (or any other movement-retarding mechanism); and the steering interface for controlling steering of the AV 110 (e.g., by changing the angle of wheels of the AV).

The communications interface 460 enables the AV 110 to communicate with other systems or servers. The communications interface 460 may interact with one or more communications components on the AV 110, e.g., a cellular data transmitter and receiver. For example, the communications interface 460 communicates with the fleet management system 120, e.g., to receive instructions from the fleet management system 120 to drive to a particular destination. The communications interface 460 may also transmit data to the fleet management system 120 describing features perceived by the perception module 430, e.g., data describing detected pedestrian activity (e.g., the locations of detected pedestrians) and data describing temporary blockages or closures of walking paths (e.g., construction or objects blocking walking paths).

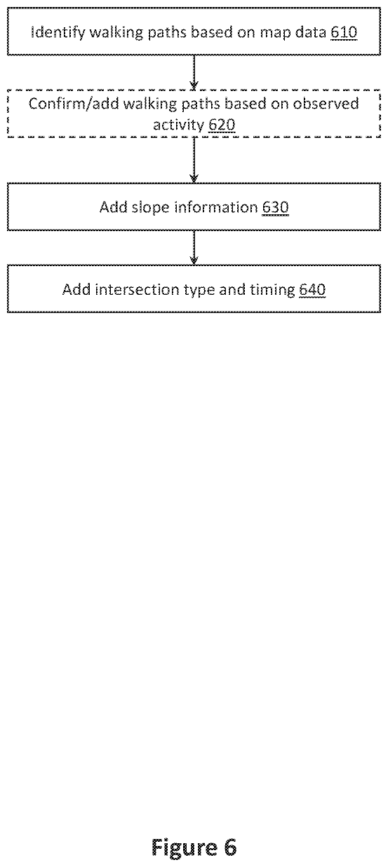

In some embodiments, the onboard computer 150 or another device of the AV 110 includes a walking path database 470 that stores data describing walking paths that can be used by pedestrians. The walking path database 470 may correspond to a geographic area described by the map database 410. The walking path database 470 stores locations of the walking paths, which may correspond to the locations of roads in the map database 410. The walking path database 470 may be generated by the fleet management system, as described with respect to FIGS. 5 and 6. The walking path database 470 is described in greater detail with respect to FIG. 5. As noted above, in some embodiments, the perception module 430 perceives closures of walking paths; the perception module 430 or another system may compare the locations of perceived features to data in the walking path database 470 to determine whether the perceived feature blocks a known walking path.

In some embodiments, the onboard computer 150 includes a walking router 480 that can determine routing routes between locations, e.g., between an origin location and a pickup location, or between a drop-off location and a destination location. For example, the AV 110 may receive a destination location, and the AV routing system 490 may determine a set of potential drop-off locations near the destination location. The walking router 480 may determine walking routes between each of the potential drop-off locations and the destination location using the walking path database. The walking router 480 may be similar to the walking router 590 described with respect to FIG. 5.

In some embodiments, the onboard computer 150 further includes an AV routing system 490 that determines a route for the AV 110. The AV routing system 490 may be used by the onboard computer 150 to select a route for the AV 110 based at least in part on a walking component of the route. For example, the AV routing system 490 may select a route for the AV 110 to a particular one of the potential drop-off locations based on the walking route from the drop-off location to the destination location as well as the driving route to the drop-off location. The AV routing system 490 may be similar to the AV routing system 550 described with respect to FIG. 5.

### Example Fleet Management System

FIG. 5 is a block diagram illustrating the fleet management system 120 according to some embodiments of the present disclosure. The fleet management system 120 includes a UI (user interface) server 510, a vehicle manager 520, a map database 530, perception data 540, an AV routing system 550, and a walking path system 560 that includes a walking path generator 570, a walking path database 580, and a walking router 590. In alternative configurations, different and/or additional components may be included in the fleet management system 120. Further, functionality attributed to one component of the fleet management system 120 may be accomplished by a different component included in the fleet management system 120 or a different system than those illustrated.

The UI server 510 is configured to communicate with client devices, such as user device 130, that provide a user interface to users. For example, the UI server 510 may be a web server that provides a browser-based application to client devices, or the UI server 510 may be a mobile app server that interfaces with a mobile app installed on client devices. The user interface enables the user to access a service of the fleet management system 120, e.g., to request a ride from an AV 110, or to request a delivery from an AV 110.

The vehicle manager 520 manages and communicates with a fleet of AVs, including AVs 110a through 110N. The UI server 510 transmits service requests received from users to the vehicle manager 520, and the vehicle manager 520 assigns AVs 110 to the service requests. More broadly, the vehicle manager 520 directs the movements of the AVs 110 in the fleet. For example, the vehicle manager 520 may instruct AVs 110 to drive to other locations while not servicing a user, e.g., to improve geographic distribution of the fleet, to anticipate demand at particular locations, to drive to a charging station for charging, etc. The vehicle manager 520 also instructs AVs 110 to return to AV facilities for recharging, maintenance, or storage. The vehicle manager 520 may interface with the AV routing system 550, which may select a route for an AV 110 to follow, and may select locations for the AV 110 to stop. In some embodiments, the AV routing system 550 is a component of the vehicle manager 520. As noted above, in various embodiments, routing functions may be distributed between the fleet management system 120 and AV 110 in different ways, with routing being directed by the fleet management system 120, routing being determined by individual AVs 110, or a combination.

As an example, the UI server 510 receives a service request from a user, such as a request for a ride, and the UI server 510 passes this request to the vehicle manager 520. The vehicle manager 520 selects an AV 110 of the fleet to carry out the service request. The vehicle manager 520 receives the origin location of the user and the destination location of the user. The AV routing system 550 determines a route for the AV 110, as described below, and transmits data describing the route to the AV 110. The vehicle manager 520 may receive updates about the location of the AV 110. The vehicle manager 520 may also handle communications with AVs 110, e.g., receiving data describing perceived pedestrians and/or perceived walking path closures, and transmitting updated walking path data (e.g., data describing blocked walking paths) to AVs 110.

The map database 530 stores a detailed map of a region or regions serviced by the AVs 110. The map database 530 may include the same data described with respect to the map database 410 in FIG. 4. The map database 530 may serve as a map data repository, and AVs 110 may retrieve copies of the map database 530, or portions of the map database 530, from the fleet management system 120. For example, the map database 530 may store maps for multiple regions (e.g., multiple states, multiple cities, and/or multiple countries), and an AV 110 in a particular region (e.g., a particular city) may download the map data for the region in which the AV 110 is operating.

The perception data 540 stores data describing pedestrian activity perceived by the fleet of AVs 110. The perception data 540 may be used by the walking path generator 570 to identify walking paths and/or determine areas that do not include walking paths. The perception data 540 may include, e.g., the locations of perceived pedestrians, or a number or frequency of perceived pedestrians at a particular location or within a given area (e.g., along a given block). In some embodiments, the perception data 540 may include data describing perceived walking path blockages, as described with respect to FIG. 4. In other embodiments, data from AVs 110 describing walking path blockages may be stored in a different database.

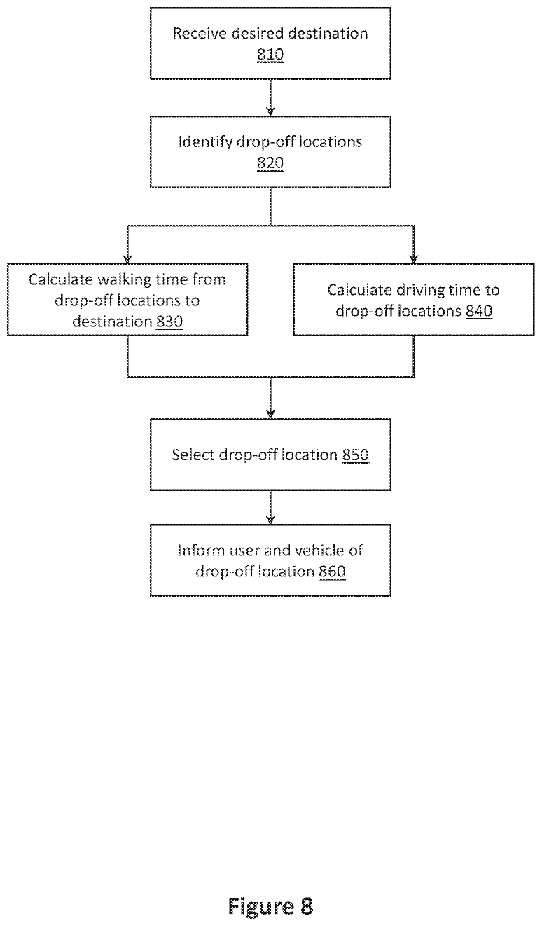

The AV routing system 550 includes hardware and/or software configured to determine a route for a particular ride. The route may be a full route, e.g., a pickup location, a drop-off location, and a route between the pickup location and the drop-off location. The route may be a partial route, e.g., a pickup location and a first portion of a driving route, or a portion of a driving route to a selected drop-off location. The AV routing system 550 may select a pickup and/or drop-off location and determine a driving route for the AV 110 and, in some cases, a walking route for a user based on the selected pickup location and/or drop-off location. Two example processes performed, at least in part, by the AV routing system 550 to determine routes for AVs 110 are shown in FIGS. 7 and 8, discussed below.

The walking path system 560 includes hardware and/or software configured to generate walking paths, store walking path data, and determine walking routes. The walking path system 560 interfaces with other components of the fleet management system 120. For example, the walking path system 560 receives data about detected pedestrians from the perception data 540, which includes data received from AVs 110. The walking path system 560 receives data about roadways from the map database 530. The walking path system 560 provides walking routes based on the walking path database 580 to the AV routing system 550. In this example, the walking path system 560 includes a walking path generator 570, a walking path database 580, and a walking router 590.

The walking path generator 570 generates walking paths for the walking path database 580. Initially, the walking path generator 570 may generate walking paths based on pedestrian paths described in the map database 530. For example, the map database 530 may include data describing sidewalks next to roadways; the walking path generator 570 may add the sidewalks to the walking path database 580. As another example, the map database 530 may include data describing crosswalks across roads or intersections; the walking path generator 570 may add the crosswalks to the walking path database 580.

In addition to clearly denoted pedestrian pathways (such as sidewalks and crosswalks), pedestrians may typically walk along the sides of the roads in other situations, e.g., along the sides of residential roads that do not have crosswalks, or along public rights-of-way at the edges of streets but above the curbs (e.g., an area on an opposite side of a curb or other roadway edge from the road). In addition, the map database 530 may not include all sidewalks. Thus, the walking path generator 570 may assume that pedestrians can walk along the sides of at least a portion of the roads in the map database 530, even if sidewalks are not specifically described in the map database. The walking path generator 570 may use one or more rules for determining whether to create a walking path along the side of a road, e.g., based on the road's width or the width of individual lanes, based on the road's speed limit, based on the number of lanes along a given road, based on the types of buildings along the road, etc.

In some embodiments, the walking path generator 570 generates walking paths based on perceived pedestrian activity. For example, the walking path generator 570 retrieves the perception data 540 describing pedestrian activity along a particular road, and if the pedestrian activity exceeds a given threshold (e.g., a threshold number of pedestrians observed, or a threshold frequency of pedestrian observations by AVs 110), the walking path generator 570 generates a walking path along the roadway. In some cases, pedestrian activity along one road or portion of road can infer pedestrian suitability of other nearby roads or portions of roads; e.g., if pedestrians are frequently observed along one street, the walking path generator 570 may generate a walking path along a parallel street if the parallel street has similar attributes (e.g., neighborhood type (residential or commercial), roadway geometry, speed limit, etc.).

In some cases, the walking path generator 570 prunes walking paths in the walking path database 580 based on perceived pedestrian activity. For example, if the pedestrian activity along a given walking path is below a given threshold (e.g., a threshold number of pedestrians observed, or a threshold frequency of pedestrian observations by AVs 110), the walking path generator 570 removes the walking path from the walking path database 580. In this case, the lack of actual pedestrian use may indicate that the path is not suitable for pedestrians.

In some embodiments, the walking path generator 570 indicates blocked walking paths in the database. As described with respect to FIG. 4, an AV 110 may detect that a walking path or a portion of a walking path is temporarily blocked or otherwise unsuitable for pedestrian traffic. The walking path generator 570 may indicate a temporary blockage in the walking path database 580. This may temporarily remove the walking path from the walking path graph. In some embodiments, the temporary blockage may be removed if a second AV 110 detects that the temporary blockage is no longer present and the walking path can be traversed by pedestrians. In some embodiments, the temporary blockage may be removed after a set period of time, e.g., 1 hour or 1 day, thus restoring the walking path to the graph. In some embodiments, temporary blockages may be stored in a separate database that is accessed by the walking path router 590 and/or other components of the fleet management system 120.

Walking paths around roadways are typically on one or both sides of a roadway, e.g., to the right of the right-most lane on either side of the roadway. Different roadways have different norms about where pedestrians cross from one side of the roadway to the other side. For example, along high-traffic roads or roads with multiple lanes (e.g., 4 or more lanes), pedestrians may typically cross a roadway only at marked crossings (e.g., crosswalks with pedestrian signals). Along medium-traffic roads, pedestrians may typically cross at intersections, but not necessarily at marked crossings. Along low-traffic roads, such as side streets in residential neighborhoods, pedestrians may typically cross at any point, e.g., on stretches of road between intersections.

In some embodiments, the walking path generator 570 determines, for a given roadway, where pedestrians can cross between walking paths on opposite sides of roadways. The walking path generator 570 may use one or more rules for determining where pedestrians can cross a particular road, e.g., based on types of intersections along the road (e.g., if the road includes marked crosswalks and/or signaled crossings, the walking path generator 570 may only include crossings at the marked crosswalks and/or signals), based on the number of lanes, based on historical levels of traffic, based on the road's speed limit, based on the types of buildings along the road (e.g., including crossings outside of intersections in a residential, low-traffic street), etc. The walking path generator 570 may adjust the crossing data for a particular road based on the observed pedestrian data retrieved from the perception data 540, e.g., including data indicating that pedestrians cross between a given roadway at particular locations based on observed pedestrian behavior, or including data that pedestrians do not cross a particular roadway outside of intersections if this pedestrian behavior is not observed.

The walking path database 580 stores data describing walking paths that can be used by pedestrians. The walking path database 580 may correspond to a geographic area described by the map database 410. The walking path database 580 may be arranged as a graph database, where edges in the database represent paths (e.g., a stretch of sidewalk, a side of a road, a crosswalk, etc.) and nodes in the graph represent connections between paths (e.g., an intersection of a crosswalk and one or more sidewalks that lead to the crosswalk). The walking path database 580 stores locations of the walking paths, which may correspond to the locations of roads in the map database 410. While roads or lanes are typically described as having a direction of travel, walking paths may be traversed in either direction.

The walking path database 580 may store additional attributes of the walking paths, some of which may be derived from the map database 530. For example, the walking path database 580 may store slope data describing slopes of the walking paths, which can impact the speed at which pedestrians can traverse the walking paths. The map database 530 may have detailed slope data, and, for example, the slope data for a lane adjacent to a particular walking path may be assumed to be the slope of the walking path.

As another example, the walking path database 580 may store data describing traffic controls controlling movement across walking paths. For example, the map database 530 stores detailed information about intersections, e.g., stop sign patterns (e.g., two way and four way stops), traffic light patterns, traffic light timing, pedestrian signaling, etc. The walking path database 580 may store data describing the type of control (e.g., stop sign or traffic light) and, in some cases, timing of the traffic lights (e.g., amount of time for a full cycle of traffic lights at an intersection). This can be used to estimate an amount of time for a pedestrian to traverse a walking path that crosses a roadway. The map database 530 may also store information about crosswalks outside of intersections, e.g., protected pedestrian crossings controlled by yield signs or lights.

As described with respect to FIG. 4, the AV 110 may also include a walking path database 470. Changes to the walking path database 580 at the fleet management system 120 may be propagated to the walking path databases 470 of the AVs 110. For example, temporary blockages observed by AVs 110 may be added to both the walking path database 580 and the walking path database 470.

The walking router 590 determines walking routes between locations based on data retrieved from the walking path database 580. For example, the AV routing system 550 may request a walking path between a pair of locations, e.g., from an origin location to a pickup location, or from a drop-off location to a destination location. The walking router 590 determines a walking route between the two locations, e.g., using a shortest path routing algorithm. The shortest path may be determined based on an expected amount of time to walk between the two locations, rather than the shortest distance. The expected amount of time to traverse a walking route may be based on distances as well as the slopes of the walking paths, e.g., according to Tobler's hiking function.

The expected amount of time to traverse a walking route may also consider delay factors of different intersections, e.g., an average or expected delay to cross at a stop sign, or an average or expected delay to cross at an intersection controlled by a traffic light. For example, in the map of FIG. 2, while the walking paths 222a and 222b have similar distances, the walking path 222a may have a longer expected walking time, since the walking path 222a includes two intersection crossings, while the walking path 222b includes only one intersection crossing.

The walking router 590 determines an optimal walking route between two locations based on the walking path data. The walking router 590 returns a routing cost (e.g., an expected time) and, in some cases, returns the geometry of the walking route (e.g., the paths traversed and the order in which they are traversed) to the AV routing system 550.

### Example Process for Generating the Walking Path Database

FIG. 6 is a flow diagram of a process for generating the walking path database 580, according to some embodiments of the present disclosure. At 610, the walking path system 560 (e.g., the walking path generator 570) identifies walking paths based on map data, e.g., data in the map database 530. For example, as described with respect to FIG. 5, the walking path generator 570 generates walking paths along at the sides of at least a portion of the roads in the map database 530. The walking path generator 570 may also generate walking paths at crosswalks or other pedestrian pathways within roads, e.g., at certain intersections. The walking path generator 570 may store data describing the generated walking paths in the walking path database 580.

In some embodiments, at 620, the walking path system 560 (e.g., the walking path generator 570) confirms and/or adds walking paths (e.g., in the walking path database 580) based on observed pedestrian activity. For example, as described with respect to FIG. 5, the walking path generator 570 may use stored data describing pedestrian activity in the perception data 540 to confirm that pedestrians walk along the sides of certain roads, e.g., along the sides of roads that do not have sidewalks. Likewise, the walking path generator 570 may use this database to remove walking paths generated based on the map data that pedestrians are not observed on. In some embodiments, pedestrian activity may not be stored, and the process 620 may be omitted.

At 630, the walking path system 560 (e.g., the walking path generator 570) adds slope information to the walking paths in the walking path database 580. As described with respect to FIG. 5, the map database 530 may include detailed information for the areas described by the map, including detailed slope information along roadways. The walking path generator 570 adds the slope data for locations corresponding to the walking paths to the walking path database 580.

At 640, the walking path system 560 (e.g., the walking path generator 570) adds intersection data for the walking paths, e.g., intersection type (marked pedestrian crossing, stop sign, traffic light, traffic light with pedestrian control, etc.) and, in some cases, intersection timing data, to the walking path database 580. In some embodiments, each intersection type may have a fixed time or delay associated with it, e.g., an expected delay of 5 seconds for a stop sign (in addition to the time to cross the intersection), or an expected delay of 20 seconds for a traffic light (in addition to the time to cross the intersection). In some embodiments, the walking path generator 570 may have bespoke timing data for individual intersections, e.g., based on a time for a light cycle at an intersection as observed by one or more AVs 110 and stored in the perception data 540.

The processes 610-640 may be performed in different orders from the order shown, e.g., processes 620-640 may be performed in any order and/or in parallel to one more other processes. Further, over time, the walking path system 560 may repeat one or more processes 610-640 to improve the walking path database, e.g., based on updated data in the map database 530 and/or additional perception data 540.

### Example Processes for Selecting a Combined Walking and Driving Route

FIGS. 7 and 8 illustrate example processes for selecting a combined walking and driving route. FIG. 7 illustrates a process for selecting a combined walking and driving route with a particular pickup location, while FIG. 8 illustrates a process for selecting a combined walking and driving route with a particular drop-off location. In some embodiments, the processes in FIGS. 7 and 8 may be combined to select a combined walking and driving route with a particular pickup location and a particular drop-off location.

Turning to FIG. 7, at 710, the fleet management system 120 receives a ride request from a user, e.g., from the user 135 or the user 210. The user may submit the ride request using the user device 130. The ride request may include an origin location of the user (e.g., the origin location 212) and a destination location of the user (e.g., the destination location 214).

At 720, the fleet management system 120 (e.g., the AV routing system 550) identifies a set of pickup locations based on the origin location. The map database 530 may store data describing suitable stopping locations, which can be used as pickup locations. The AV routing system 550 may select a set of stopping locations proximate to the origin location as the set of potential pickup locations. For example, the AV routing system 550 may select a certain number of stopping locations based on their distance to the origin location (e.g., the three nearest stopping locations to the origin location, or the 10 nearest stopping locations to the origin location). As another example, the AV routing system 550 may select stopping locations within a given distance to the origin location (e.g., all stopping locations within 100 meters of the origin location). If fewer than a threshold number of stopping locations are within the given distance (e.g., less than three), the AV routing system 550 may select additional stopping locations within a second, larger distance of the origin location (e.g., all stopping locations within 200 meters of the origin location). The radius may be expanded until a threshold number of stopping locations are identified.

At 730, the fleet management system 120 (e.g., the walking router 590) calculates walking times from the origin location to each of the set of pickup locations. As described with respect to FIG. 5, the walking router 590 may determine an optimal walking path, e.g., the walking path with the shortest total walking time. The walking time may be based on the distance traveled, the slopes of the walking paths, and any delays, e.g., delays for crossing intersections.

At 740, the fleet management system 120 (e.g., the AV routing system 550) calculates a driving time from each of the set of pickup locations to the destination location. For example, for each of the pickup locations, the AV routing system 550 determines an optimal driving route (e.g., the driving route with the shortest total driving time) from the pickup location and calculates the driving time for the optimal route. In some embodiments, the AV routing system 550 may calculate an optimal route based on one or more additional factors, e.g., fuel or energy consumption, ride comfort, fewer turns, etc. As shown in FIG. 7, the processes 730 and 740 may be performed in parallel; alternatively, the processes 730 and 740 may be performed in sequence, with either process 730 or 740 performed before the other.

At 750, the fleet management system 120 (e.g., the AV routing system 550) selects a combined route, where the combined route includes one of the set of pickup locations. For example, the AV routing system 550 may calculate a combined score for each possible combined route, where a combined route includes a walking segment (from the origin location to a particular pickup location) and a driving segment (from the particular pickup location to the destination location). The combined score may be a total time to traverse the route. In some embodiments, the AV routing system 550 may include weighting factors on different components of the score, e.g., applying a greater weight to the walking time, so that if two combined routes have similar overall times, the AV routing system 550 chooses the combined route that reduces walking time for the user. The AV routing system 550 selects a combined route based on the combined scores, e.g., selecting the combined route with the lowest score or the highest score, depending on how the scores are calculated.

In some embodiments, the AV routing system 550 also considers the current locations of one or more AVs 110, and how quickly the AVs 110 can reach the pickup locations. If an AV 110 cannot reach a first pickup location at the time that the user would be expected to reach the first pickup location, but the same AV 110 or a different AV can reach a second pickup location at the time that the user would be expected to reach the second pickup location, the AV routing system 550 may select the combined route with the second pickup location. More generally, the AV routing system 550 selects a combined route that has the shortest overall travel time, where a delay for the AV 110 to reach the pickup location is incorporated into the travel time.

At 760, the fleet management system 120 informs both the user and the vehicle (e.g., the AV 110) of the pickup location. For example, the AV routing system 550 passes the pickup location to the vehicle manager 520, and the vehicle manager 520 instructs the AV 110 to drive to the pickup location. The AV routing system 550 and/or the vehicle manager 520 may select a particular AV 110, e.g., the AV 110 closest to the pickup location. The AV routing system 550 may also pass the selected pickup location to the UI server 510, which provides the pickup location to the user device 130. The user device 130 may display the pickup location to the user 135, and in some embodiments, the user device 130 provides a walking route from the origin location to the pickup location.

FIG. 8 is a flow diagram of a process for selecting a combined walking and driving route with a particular drop-off location. The process in FIG. 8 may be performed by a fleet management system 120 (e.g., with certain steps performed by the AV routing system 550 of the fleet management system 120) or an AV 110 (e.g., with certain steps performed by the AV routing system 490 of the AV 110). In some embodiments, the process of FIG. 8 is performed in part by the AV 110 and in part by the fleet management system 120.

At 810, the fleet management system 120 or AV 110 receives a desired destination, e.g., a destination input with a ride request from the user 135 or the user 210. If the AV 110 performs the process of FIG. 8, the AV 110 may receive the input destination from the vehicle manager 520.

At 820, a routing system (e.g., the AV routing system 490 or the AV routing system 550) identifies a set of drop-off locations based on the destination location. The map database 410 or 530 may store data describing suitable stopping locations, which can be used as drop-off locations. The AV routing system 490 or 550 may select a set of stopping locations proximate to the destination location as the set of potential drop-off locations. For example, the AV routing system 490 or 550 may select a certain number of stopping locations based on their distance to the destination location (e.g., the three nearest stopping locations to the destination location, or the 10 nearest stopping locations to the destination location). As another example, the AV routing system 490 or 550 may select stopping locations within a given distance to the destination location (e.g., all stopping locations within 100 meters of the destination location). If fewer than a threshold number of stopping locations are within the given distance (e.g., less than three), the AV routing system 490 or 550 may select additional stopping locations within a second, larger distance of the destination location (e.g., all stopping locations within 200 meters of the destination location). The radius may be expanded until a threshold number of stopping locations are identified.

At 830, the fleet management system 120 (e.g., the walking router 590) or the AV 110 (e.g., the walking router 480) calculates walking times from each of the set of drop-off locations to the destination location. As described with respect to FIG. 5, the walking router 480 or 590 may determine an optimal walking path, e.g., the walking path with the shortest total walking time. The walking time may be based on the distance traveled, the slopes of the walking paths, and any delays, e.g., delays for crossing intersections.

At 840, the fleet management system 120 (e.g., the AV routing system 550) or the AV 110 (e.g., the AV routing system 490) calculates a driving time from an origin location (e.g., a previously-selected pickup location, or the current location of the AV 110) to each of the set of drop-off locations. For example, for each of the drop-off locations, the AV routing system 490 or 550 determines an optimal driving route (e.g., the driving route with the shortest total driving time) to the drop-off location and calculates the driving time for the optimal route. In some embodiments, the AV routing system 490 or 550 may calculate an optimal route based on one or more additional factors, e.g., fuel or energy consumption, ride comfort, fewer turns, etc. As shown in FIG. 8, the processes 830 and 840 may be performed in parallel; alternatively, the processes 830 and 840 may be performed in sequence, with either process 830 or 840 performed before the other.

At 850, the fleet management system 120 (e.g., the AV routing system 550) or the AV 110 (e.g., the AV routing system 490) selects a combined route, where the combined route includes one of the set of drop-off locations. For example, the AV routing system 490 or 550 may calculate a combined score for each possible combined route, where a combined route includes a walking segment (from a particular drop-off location to the destination location) and a driving segment (to the particular drop-off location). The combined score may be a total time to traverse the route. In some embodiments, the AV routing system 490 or 550 may include weighting factors on different components of the score, e.g., applying a greater weight to the walking time, so that if two combined routes have similar overall times, the AV routing system 490 or 550 chooses the combined route that reduces walking time for the user. The AV routing system 490 or 550 selects a combined route based on the combined scores, e.g., selecting the combined route with the lowest score or the highest score, depending on how the scores are calculated.

At 860, the fleet management system 120 informs both the user and the vehicle (e.g., the AV 110) of the drop-off location. For example, the AV routing system 550 passes the drop-off location to the vehicle manager 520, and the vehicle manager 520 instructs the AV 110 to drive to the drop-off location. The AV routing system 550 may also pass the selected drop-off location to the UI server 510, which provides the drop-off location to the user device 130. The user device 130 may display the drop-off location to the user 135, and in some embodiments, the user device 130 provides a walking route from the drop-off location to the destination location. Alternatively, if the AV 110 selects the drop-off location, the AV 110 may inform the fleet management system 120 of the selected drop-off location, and the fleet management system 120 may inform the user. In some embodiments, the AV 110 may display the selected drop-off location in an in-vehicle user interface.

While the systems and methods described herein are generally directed to routing for passenger travel, in other embodiments, the walking directions and selection of a stopping location can be used for delivery applications. For example, if a user requested delivery of an item (e.g., food, groceries, or other items) to a particular destination that cannot be directly reached by an AV, the AV routing system 490 or 550 may select a drop-off location for the AV 110 to stop and the user to collect the delivery items based on both the walking trip for the user to the drop-off location and the driving route to the drop-off location. For example, the AV routing system 490 or 550 may select a drop-off location from a set of potential drop-off locations that results in the lowest overall time for the items to get to the user's destination. The AV routing system 490 or 550 may weigh the walking segment, as in a delivery application, it is generally more useful for the items to get closer to the destination and to reduce the amount of walking; nevertheless, if routing the AV 110 to the closest stopping location to the destination location takes significantly longer than a slightly farther stopping location, a user may prefer to walk to the slightly farther stopping location. In some embodiments, the AV routing system 490 or 550 may consider the delivery load (e.g., the number of items, the weight of the items) in determining how to weigh the walking segment, e.g., having a stronger preference for driving over walking for larger or more cumbersome loads. As another example, the AV routing system 490 or 550 may apply an additional weighting factor (e.g., beyond Tobler's hiking function) to sloped walking pathways, having a stronger preference for flatter walking pathways.

### Select Examples

Example 1 provides a method including receiving a ride request from a user, the ride request including an origin location and a destination location; identifying a plurality of pickup locations proximate to the origin location; generating a plurality of routes to the destination location, each of the plurality of routes including a walking segment to one of the plurality of pickup locations and a driving segment from the one of the plurality of pickup locations to the destination location, the walking segment generated based on a walking path database; generating a score for each of the plurality of routes, the score based in part on an expected time to traverse each of the walking segments of the plurality of routes; selecting one of the plurality of routes based on the scores, the route including a selected pickup location; and instructing a vehicle to drive to the selected pickup location.

Example 2 provides the method of example 1, where the walking path database includes data describing a crosswalk across a roadway, the data derived from sensor data collected by one or more sensors of an autonomous vehicle (AV).

Example 3 provides the method of any preceding example, where the walking path database includes a pathway observed as being used by a perceived pedestrian, where the pedestrian was perceived based on sensor data collected by one or more sensors of an autonomous vehicle (AV).

Example 4 provides the method of any preceding example, where the walking path database includes data describing a pair of pathways separated by a roadway; and data describing whether pedestrians cross the roadway between the pair of pathways in the absence of a crosswalk.

Example 5 provides the method of any preceding example, where the walking path database includes intersection data describing traffic controls at intersections, the method further including generating, for one of the walking segments, the expected time to traverse the walking segment, the walking segment including an intersection, and the expected time including a time to traverse the intersection based on a traffic control at the intersection.

Example 6 provides the method of any preceding example, further including identifying a plurality of drop-off locations proximate to the destination location; generating a second plurality of routes to the destination location, each of the second plurality of routes including a second driving segment to one of the drop-off locations and a second walking segment to the one of the drop-off locations, the second walking segment generated based on the walking path database; generating second scores for the second plurality of routes based in part on an expected time to traverse each of the second walking segments of the second plurality of routes; selecting one of the second plurality of routes based on the second scores, the route including a selected drop-off location; and instructing the vehicle to drive to the selected drop-off location.

Example 7 provides the method of any preceding example, where the walking path database includes a temporary blockage of a walking path, the temporary blockage perceived by an autonomous vehicle (AV), and generating one of the plurality of routes includes generating a walking portion that avoids the temporary blockage.

Example 8 provides a non-transitory computer-readable medium storing instructions that, when executed by a processor, cause the processor to: receive a ride request from a user, the ride request including an origin location and a destination location; identify a plurality of pickup locations proximate to the origin location; generate a plurality of routes to the destination location, each of the plurality of routes including a walking segment to one of the plurality of pickup locations and a driving segment from the one of the plurality of pickup locations to the destination location, the walking segment generated based on a walking path database; generate a score for each of the plurality of routes, the score based in part on an expected time to traverse each of the walking segments of the plurality of routes; select one of the plurality of routes based on the scores, the route including a selected pickup location; and instruct a vehicle to drive to the selected pickup location.

Example 9 provides the non-transitory computer-readable medium of example 8, where the walking path database includes data describing a crosswalk across a roadway, the data derived from sensor data collected by one or more sensors of an autonomous vehicle (AV).

Example 10 provides the non-transitory computer-readable medium of example 8 or 9, where the walking path database includes a pathway observed as being used by a perceived pedestrian, where the pedestrian was perceived based on sensor data collected by one or more sensors of an autonomous vehicle (AV).

Example 11 provides the non-transitory computer-readable medium of any of examples 8-10, where the walking path database includes data describing a pair of pathways separated by a roadway; and data describing whether pedestrians cross the roadway between the pair of pathways in the absence of a crosswalk.

Example 12 provides the non-transitory computer-readable medium of any of examples 8-10, where the walking path database includes intersection data describing traffic controls at intersections, and the instructions further cause the processor to: generate, for one of the walking segments, the expected time to traverse the walking segment, the walking segment including an intersection, and the expected time including a time to traverse the intersection based on a traffic control at the intersection.

Example 13 provides the non-transitory computer-readable medium of any of examples 8-10, where the instructions further cause the processor to: identify a plurality of drop-off locations proximate to the destination location; generate a second plurality of routes to the destination location, each of the second plurality of routes including a second driving segment to one of the drop-off locations and a second walking segment to the one of the drop-off locations, the second walking segment generated based on the walking path database; generate second scores for the second plurality of routes based in part on an expected time to traverse each of the second walking segments of the second plurality of routes; select one of the second plurality of routes based on the second scores, the route including a selected drop-off location; and instruct the vehicle to drive to the selected drop-off location.

Example 14 provides the non-transitory computer-readable medium of example 8, where the walking path database includes a temporary blockage of a walking path, the temporary blockage perceived by an autonomous vehicle (AV), and generating one of the plurality of routes includes generating a walking portion that avoids the temporary blockage.

Example 15 provides an apparatus, including a computer processor for executing computer program instructions; and a non-transitory computer-readable memory storing computer program instructions executable by the computer processor to perform operations including receiving a ride request from a user, the ride request including an origin location and a destination location; identifying a plurality of pickup locations proximate to the origin location; generating a plurality of routes to the destination location, each of the plurality of routes including a walking segment to one of the plurality of pickup locations and a driving segment from the one of the plurality of pickup locations to the destination location, the walking segment generated based on a walking path database; generating a score for each of the plurality of routes, the score based in part on an expected time to traverse each of the walking segments of the plurality of routes; selecting one of the plurality of routes based on the scores, the route including a selected pickup location; and instructing a vehicle to drive to the selected pickup location.

Example 16 provides the apparatus of example 15, where the walking path database includes data describing a crosswalk across a roadway, the data derived from sensor data collected by one or more sensors of an autonomous vehicle (AV).

Example 17 provides the apparatus of example 15 or 16, where the walking path database includes a pathway observed as being used by a perceived pedestrian, where the pedestrian was perceived based on sensor data collected by one or more sensors of an autonomous vehicle (AV).

Example 18 provides the apparatus of any of examples 15-17, where the walking path database includes data describing a pair of pathways separated by a roadway; and data describing whether pedestrians cross the roadway between the pair of pathways in the absence of a crosswalk.

Example 19 provides the apparatus of any of examples 15-18, where the walking path database includes intersection data describing traffic controls at intersections, the operations further including generating, for one of the walking segments, the expected time to traverse the walking segment, the walking segment including an intersection, and the expected time including a time to traverse the intersection based on a traffic control at the intersection.

Example 20 provides the apparatus of any of examples 15-19, the operations further including identifying a plurality of drop-off locations proximate to the destination location; generating a second plurality of routes to the destination location, each of the second plurality of routes including a second driving segment to one of the drop-off locations and a second walking segment to the one of the drop-off locations, the second walking segment generated based on the walking path database; generating second scores for the second plurality of routes based in part on an expected time to traverse each of the second walking segments of the second plurality of routes; selecting one of the second plurality of routes based on the second scores, the route including a selected drop-off location; and instructing the vehicle to drive to the selected drop-off location.

### OTHER IMPLEMENTATION NOTES, VARIATIONS, AND APPLICATIONS

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

What is claimed is:

1. A method comprising:
receiving a ride request from a user, the ride request comprising an origin location and a destination location;
identifying a plurality of pickup locations proximate to the origin location;
generating a plurality of routes to the destination location, each of the plurality of routes comprising a walking segment to one of the plurality of pickup locations and a driving segment from the one of the plurality of pickup locations to the destination location, the walking segment generated based on a walking path database;
generating a score for each of the plurality of routes, the score based in part on an expected time to traverse each of the walking segments of the plurality of routes;
selecting one of the plurality of routes based on the scores, the route comprising a selected pickup location; and
instructing a vehicle to drive to the selected pickup location.

2. The method of claim 1, wherein the walking path database comprises data describing a crosswalk across a roadway, the data derived from sensor data collected by one or more sensors of an autonomous vehicle (AV).

3. The method of claim 1, wherein the walking path database comprises a pathway observed as being used by a perceived pedestrian, wherein the pedestrian was perceived based on sensor data collected by one or more sensors of an autonomous vehicle (AV).

4. The method of claim 1, wherein the walking path database comprises:
data describing a pair of pathways separated by a roadway; and
data describing whether pedestrians cross the roadway between the pair of pathways in the absence of a crosswalk.

5. The method of claim 1, wherein the walking path database comprises intersection data describing traffic controls at intersections, the method further comprising:
generating, for one of the walking segments, the expected time to traverse the walking segment, the walking segment including an intersection, and the expected time including a time to traverse the intersection based on a traffic control at the intersection.

6. The method of claim 1, further comprising:
identifying a plurality of drop-off locations proximate to the destination location;
generating a second plurality of routes to the destination location, each of the second plurality of routes comprising a second driving segment to one of the drop-off locations and a second walking segment to the one of the drop-off locations, the second walking segment generated based on the walking path database;
generating second scores for the second plurality of routes based in part on an expected time to traverse each of the second walking segments of the second plurality of routes;
selecting one of the second plurality of routes based on the second scores, the route comprising a selected drop-off location; and
instructing the vehicle to drive to the selected drop-off location.

7. The method of claim 1, wherein the walking path database includes a temporary blockage of a walking path, the temporary blockage perceived by an autonomous vehicle (AV), and generating one of the plurality of routes comprises generating a walking portion that avoids the temporary blockage.

8. A non-transitory computer-readable medium storing instructions that, when executed by a processor, cause the processor to:
receive a ride request from a user, the ride request comprising an origin location and a destination location;
identify a plurality of pickup locations proximate to the origin location;
generate a plurality of routes to the destination location, each of the plurality of routes comprising a walking segment to one of the plurality of pickup locations and a driving segment from the one of the plurality of pickup locations to the destination location, the walking segment generated based on a walking path database;
generate a score for each of the plurality of routes, the score based in part on an expected time to traverse each of the walking segments of the plurality of routes;
select one of the plurality of routes based on the scores, the route comprising a selected pickup location; and
instruct a vehicle to drive to the selected pickup location.

9. The non-transitory computer-readable medium of claim 8, wherein the walking path database comprises data describing a crosswalk across a roadway, the data derived from sensor data collected by one or more sensors of an autonomous vehicle (AV).

10. The non-transitory computer-readable medium of claim 8, wherein the walking path database comprises a pathway observed as being used by a perceived pedestrian, wherein the pedestrian was perceived based on sensor data collected by one or more sensors of an autonomous vehicle (AV).

11. The non-transitory computer-readable medium of claim 8, wherein the walking path database comprises:
data describing a pair of pathways separated by a roadway; and
data describing whether pedestrians cross the roadway between the pair of pathways in the absence of a crosswalk.

12. The non-transitory computer-readable medium of claim 10, wherein the walking path database comprises intersection data describing traffic controls at intersections, and the instructions further cause the processor to:
generate, for one of the walking segments, the expected time to traverse the walking segment, the walking segment including an intersection, and the expected time including a time to traverse the intersection based on a traffic control at the intersection.

13. The non-transitory computer-readable medium of claim 8, wherein the instructions further cause the processor to:
identify a plurality of drop-off locations proximate to the destination location;
generate a second plurality of routes to the destination location, each of the second plurality of routes comprising a second driving segment to one of the drop-off locations and a second walking segment to the one of the drop-off locations, the second walking segment generated based on the walking path database;
generate second scores for the second plurality of routes based in part on an expected time to traverse each of the second walking segments of the second plurality of routes;
select one of the second plurality of routes based on the second scores, the route comprising a selected drop-off location; and
instruct the vehicle to drive to the selected drop-off location.

14. The non-transitory computer-readable medium of claim 8, wherein the walking path database includes a temporary blockage of a walking path, the temporary blockage perceived by an autonomous vehicle (AV), and generating one of the plurality of routes comprises generating a walking portion that avoids the temporary blockage.

15. An apparatus, comprising:
a computer processor for executing computer program instructions; and
a non-transitory computer-readable memory storing computer program instructions executable by the computer processor to perform operations comprising:
receiving a ride request from a user, the ride request comprising an origin location and a destination location;
identifying a plurality of pickup locations proximate to the origin location;
generating a plurality of routes to the destination location, each of the plurality of routes comprising a walking segment to one of the plurality of pickup locations and a driving segment from the one of the plurality of pickup locations to the destination location, the walking segment generated based on a walking path database;
generating a score for each of the plurality of routes, the score based in part on an expected time to traverse each of the walking segments of the plurality of routes;
selecting one of the plurality of routes based on the scores, the route comprising a selected pickup location; and
instructing a vehicle to drive to the selected pickup location.

16. The apparatus of claim 15, wherein the walking path database comprises data describing a crosswalk across a roadway, the data derived from sensor data collected by one or more sensors of an autonomous vehicle (AV).

17. The apparatus of claim 15, wherein the walking path database comprises a pathway observed as being used by a perceived pedestrian, wherein the pedestrian was perceived based on sensor data collected by one or more sensors of an autonomous vehicle (AV).

18. The apparatus of claim 15, wherein the walking path database comprises:
data describing a pair of pathways separated by a roadway; and
data describing whether pedestrians cross the roadway between the pair of pathways in the absence of a crosswalk.

19. The apparatus of claim 15, wherein the walking path database comprises intersection data describing traffic controls at intersections, the operations further comprising:
generating, for one of the walking segments, the expected time to traverse the walking segment, the walking segment including an intersection, and the expected time including a time to traverse the intersection based on a traffic control at the intersection.

20. The apparatus of claim 15, the operations further comprising:
identifying a plurality of drop-off locations proximate to the destination location;
generating a second plurality of routes to the destination location, each of the second plurality of routes comprising a second driving segment to one of the drop-off locations and a second walking segment to the one of the drop-off locations, the second walking segment generated based on the walking path database;
generating second scores for the second plurality of routes based in part on an expected time to traverse each of the second walking segments of the second plurality of routes;
selecting one of the second plurality of routes based on the second scores, the route comprising a selected drop-off location; and
instructing the vehicle to drive to the selected drop-off location.
